(19) United States
(12) Patent Application Publication
(10) Pub. No.: US 2025/0076547 A1
(43) Pub. Date: Mar. 6, 2025

(54) METHOD OF MANUFACTURING A PLURALITY OF OPTICAL DEVICES AND OPTICAL DEVICE

(71) Applicant: Applied Materials, Inc., Santa Clara, CA (US)

(72) Inventors: Davide COLLA, Treviso (IT); Rutger MEYER TIMMERMAN THIJSSEN, San Jose, CA (US); Neal RICKS, San Jose, CA (US); Kevin MESSER, Mountain View, CA (US)

(21) Appl. No.: 18/825,091

(22) Filed: Sep. 5, 2024

Related U.S. Application Data
(60) Provisional application No. 63/536,737, filed on Sep. 6, 2023.

(51) Int. Cl. G02B 5/00; F21V 8/00; G02B 1/00

(52) U.S. Cl. CPC G02B 5/003; G02B 6/0016; G02B 6/0026; G02B 6/0036; G02B 6/0065; G02B 1/002

(57) ABSTRACT

An optical device comprising a substrate with a front surface, a back surface and a circumferential side surface is described. At least one portion of an edge of the front surface has a texturization, wherein recesses of the texturization are filled with a light-absorbent material. The circumferential side surface is free of light-absorbent material. Further, a method of manufacturing a plurality of optical devices is described

### FIELD

Embodiments of the present disclosure relate to methods of manufacturing a plurality of optical devices, such as waveguides, wave guide combiners, flat optical devices, substrates having optical structures, cover glasses, lenses, metasurface lenses and the like.

### BACKGROUND

Virtual reality (VR) is generally considered to be a computer-generated simulated environment in which a user has an apparent physical presence. A VR experience can be generated in 3D and viewed with a head-mounted display (HMD), such as glasses or other wearable display devices that have near-eye display panels as lenses for displaying a VR environment that replaces an actual environment.

Augmented reality (AR), however, enables an experience in which a user can still see through the display lenses of the glasses or other HMD device to view the surrounding environment, yet also see images of virtual objects that are generated for display and appear as part of the environment. AR can include any type of input, such as audio and haptic inputs, as well as virtual images, graphics, and video that enhances or augments the environment that the user experiences. In order to achieve an AR experience, a virtual image is overlaid on an ambient environment, the overlaying being performed by optical devices.

Optical devices may be used to manipulate the propagation of light using structures of the optical device formed on an optical device substrate. These structures alter light propagation by inducing localized phase discontinuities (i.e., abrupt changes of phase over a distance smaller than the wavelength of light). These structures may be composed of different types of materials, shapes, or configurations on the optical device substrate and may operate based upon different physical principles. Fabricating optical devices includes depositing and patterning device material disposed on one or more substrates. Multiple optical devices may be manufactured on a single substrate, and the optical devices are typically diced from the substrate at the end of the process flow. As an emerging technology, augmented reality faces many challenges and design constraints.

One such challenge is displaying a virtual image overlaid on an ambient environment. Waveguide combiners, such as augmented reality waveguide combiners, are used to assist in overlaying images. Generated light is propagated through a waveguide combiner until the light exits the waveguide combiner and is overlaid on the ambient environment. The optical performance of a waveguide may be greatly impacted by an insufficient absorption of the scattered light; in particular, the contrast may be reduced.

In light of the above, there is demand to provide optical devices and manufacturing methods therefor, with which one or more problems of the state of the art can be overcome and are improved with respect to conventional optical devices and manufacturing methods.

### SUMMARY

In light of the above, a method of manufacturing a plurality of optical devices and an optical device according to the independent claims are provided. Further features, details, aspects, implementation and embodiments are shown in the dependent claims, the description and the drawings.

According to an aspect of the present disclosure, a method of manufacturing a plurality of optical devices is provided. The method includes defining individual edges of the plurality of optical devices on a substrate surface. Additionally, the method includes texturizing at least one portion of the individual edges by removing material from the substrate surface. Furthermore, the method includes filling recesses of the at least one texturized portion with a light-absorbent material. Moreover, the method includes cutting the plurality of optical devices out of the substrate.

According to another aspect of the present disclosure, an optical device is provided. The optical device includes a substrate with a front surface, a back surface and a circumferential side surface. At least one portion of an edge of the front surface has a texturization. Recesses of the texturization are filled with a light-absorbent material. The circumferential side surface is free of light-absorbent material.

Embodiments are also directed at apparatuses for carrying out the disclosed methods and include apparatus parts for performing each described method aspect. These method aspects may be performed by way of hardware components, a computer programmed by appropriate software, by any combination of the two or in any other manner. Furthermore, embodiments according to the disclosure are also directed at methods for operating the described apparatus. The methods for operating the described apparatus include method aspects for carrying out every function of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG.1 shows a schematic illustration of a method of manufacturing a plurality of optical devices according to embodiments described herein;

FIGS. 2A and 2B show schematic illustrations of a waveguide;

FIG. 3 shows a waveguide stack including several waveguides;

FIG. 4 shows a schematic top view of an optical device according to embodiments described herein;

FIG. 5 shows a schematic partial sectional view of an optical device according to embodiments described herein; and

FIG. 6 shows a schematic partial sectional view of an optical device according to further embodiments described herein.

### DETAILED DESCRIPTION OF EMBODIMENTS

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations. Within the following description of the drawings, the same reference numbers refer to the same or to similar components. Generally, only the differences with respect to the individual embodiments are described. Unless specified otherwise, the description of a part or aspect in one embodiment can apply to a corresponding part or aspect in another embodiment as well.

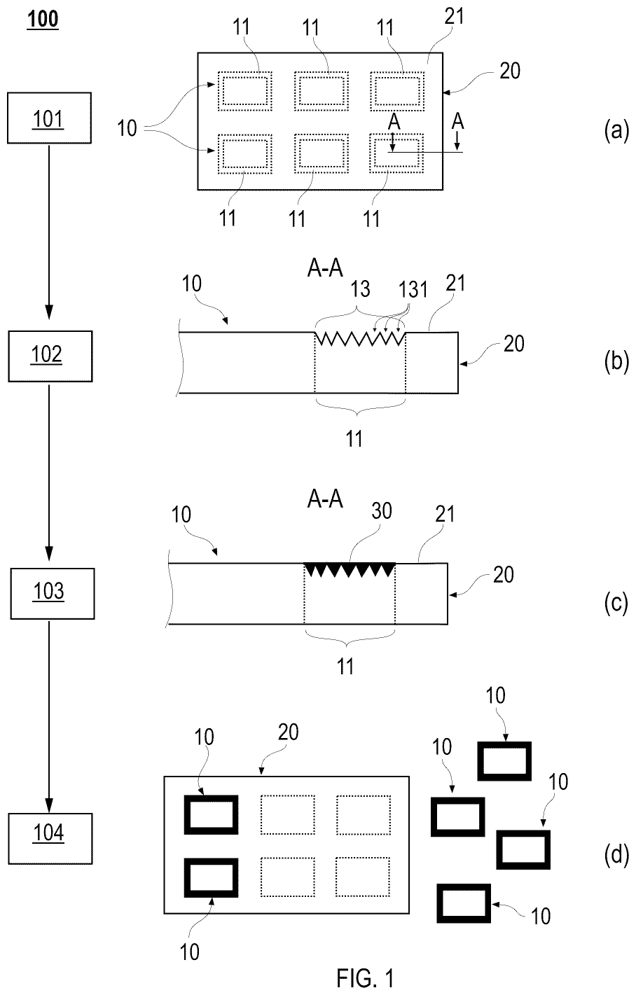

With exemplary reference to FIG. 1, a method 100 of manufacturing a plurality of optical devices 10 according to the present disclosure is described. According to embodiments, which can be combined with any other embodiments described herein, the method 100 includes defining (represented by block 101 in FIG. 1) individual edges 11 of the plurality of optical devices 10 on a substrate surface 21. Additionally, the method 100 includes texturizing (represented by block 102 in FIG. 1) at least one portion of the individual edges 11 by removing material from the substrate surface 21. Further, the method 100 includes filling (represented by block 103 in FIG. 1) recesses 131 of the at least one texturized portion 13 with a light-absorbent material 30. Moreover, the method 100 includes cutting (represented by block 104 in FIG. 1) the plurality of optical devices 10 out of the substrate 20.

Accordingly, as described in more detail in the following, compared to the state of the art, the method of manufacturing a plurality of optical devices according to the present disclosure offers numerous advantages. It allows for scalable and efficient production of multiple devices simultaneously, ensuring precision and consistency in their shape and size. The customization capability achievable by texturizing individual edges enables enhanced functionality. In particular, filling the recesses with a light-absorbent material optimizes optical performance by reducing reflections and stray light. Further, the method as described herein has the advantage that it can be carried out at wafer level, which has advantages in terms of lean manufacturing and productivity. Additionally, the method streamlines the manufacturing process, improves material utilization, and facilitates quality control. Overall, this method provides cost-effective production, consistent quality, and enhanced functionality in optical applications.

Before various further embodiments of the present disclosure are described in more detail, some aspects with respect to some terms used herein are explained.

In the present disclosure, a “method of manufacturing a plurality of optical devices” can be understood as a process or procedure for producing multiple optical devices, particularly simultaneously. In this context, “plurality” means a large number or a variety of devices, indicating that the method is intended to create large quantities of optical devices rather than just one.

In the present disclosure, the an “optical device” can be understood as a device, component, or system that interacts with light or utilizes the properties of light for various purposes. In particular, typically, an optical device is configured or designed to manipulate, control, or detect light in order to achieve specific functions or applications. Typically, at least a portion of the optical device is made of a transparent material, such as glass or plastic. Some optical devices may be configured to change the properties, e.g. the propagation direction, of light. For example, an optical device may include optical structures for changing the propagation direction of light. Other optical devices may be unstructured and allow light to pass therethrough substantially unaltered. An optical device as described herein may be an optical device for use in augmented reality applications. An optical device can also be called an optical element. Examples of optical devices include waveguides and transparent cover elements, such as cover glasses, as described herein.

An optical device as described herein, such as a waveguide or a transparent cover element, can be a thin piece of material. An optical device can be a plate element, including a plate element having a flat surface or a plate element having a curved surface. An optical device can have a first major surface and a second major surface opposite the first major surface. An optical device may be a substantially two-dimensional device, wherein a thickness of the optical device between the first major surface and the second major surface can be much smaller (e.g. 1% or less) than a dimension, such as a length or width, of the first or second major surface. For example, the thickness of an optical device may be 1 mm, 500 μm or 300 μm or less.

According to embodiments, which can be combined with any other embodiments described herein, the optical device is selected from the group consisting of: a waveguide, a wave guide combiner, a flat optical device, a substrate having optical structures, a cover glass, a lens, a metasurface lens, and a stack of at least one waveguide and at least one cover glass.

A metasurface lens is a type of optical device that uses an array of subwavelength-scale structures called meta-atoms to manipulate light waves. Unlike traditional lenses, which rely on gradual changes in refractive index to focus light, metasurface lenses achieve control over light by precisely engineering the shape, size, and orientation of these subwavelength structures.

A metasurface lens typically consists of a planar surface containing an arrangement of meta-atoms, which can be made from various materials such as metals or dielectrics. Each meta-atom is designed to impart a specific phase delay to the incident light wave. By carefully designing the size, shape, and arrangement of the meta-atoms, the metasurface lens can control the direction, amplitude, and phase of the transmitted or reflected light, enabling various optical functions.

One of the key advantages of metasurface lenses is their ability to manipulate light with exceptional precision and flexibility. They can be engineered to exhibit unique properties, including negative refraction, anomalous dispersion, polarization control, and focusing capabilities that surpass the limitations of traditional lenses. Metasurface lenses can also be much thinner and lighter than conventional lenses, making them suitable for compact optical systems and integration with other devices.

The design process of a metasurface lens involves sophisticated computational techniques, such as inverse design algorithms or optimization methods, in order to determine the desired characteristics and parameters of the meta-atoms. Once the design is finalized, the metasurface lens can be fabricated using advanced nanofabrication techniques, such as electron beam lithography or nanoimprint lithography, to precisely pattern the meta-atoms on a substrate.

Metasurface lenses have found applications in various areas, including imaging systems, augmented and virtual reality devices, optical communications, microscopy, and beam shaping. They offer new possibilities for designing and miniaturizing optical systems, enabling improved performance and opening doors for emerging technologies.

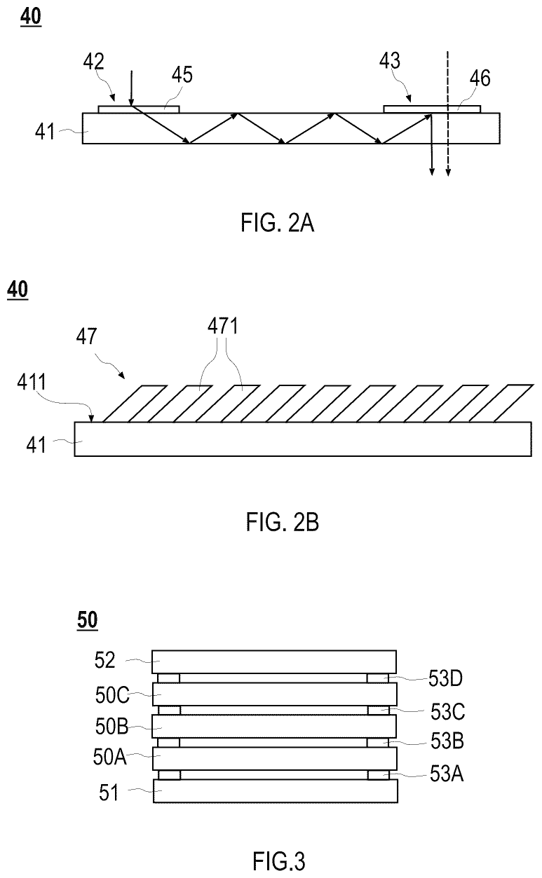

FIGS. 2A and 2B show an exemplary waveguide 40. As shown in FIG. 2A, the waveguide 40 may include a substrate 41, which may be a thin piece of transparent material, such as glass or plastic. At least one grating structure, such as a first grating structure 42 and a second grating structure 43, may be disposed on the substrate 41. The waveguide 40 may include an input coupling region 45 defined by the first grating structure 42. The waveguide 40 may include an output coupling region 46 defined by the second grating structure 43. Light, in particular light corresponding to a virtual, computer-generated image, may be coupled into the waveguide 40 at the input coupling region 45. The light may propagate through the waveguide 40 until the light reaches the output coupling region 46. At the output coupling region 46, the light may exit the waveguide 40. Further, also at the output coupling region 46, light from the external, real-world surroundings may be transmitted through the waveguide 40 (as shown by the dashed line), allowing the user to see a combination of a virtual image and a real-world image. The waveguide 40 may be a waveguide combiner for providing an augmented reality experience to a user.

FIG. 2B shows a grating structure 47 of a waveguide 40 in more detail. The grating structure 47 may be the first grating structure 42 or the second grating structure 43 shown in FIG. 2A, and may accordingly serve to provide an input coupling region or an output coupling region of the waveguide 40. The grating structure 47 may be formed on a major surface 411 of the substrate 41. The grating structure 47 may include a plurality of optical structures 471. The optical structures 471 may be configured to change a propagation direction of light incident on the grating structure 47. The optical structures 471 may have dimensions, e.g. width and/or height, that lie in the sub-micron and even nanometer range. The optical structures may be arranged adjacent to each other with a gap in between. As shown in FIG. 2B, the optical structures 471 may be shaped, for example, as slanted fins.

The disclosure is not limited to the exemplary waveguide 40 shown in FIGS. 2A and 2B, and applies likewise to other waveguides. For example, a waveguide may have more than two grating structures (e.g. the waveguide may have one or more intermediate regions defined by further grating structures), the arrangement and shape of the optical structures 471 may be different from the example shown in FIG. 2B, the waveguide may have grating structures disposed on both sides of the waveguide, and so on.

In an optical system, such as an augmented reality device, several waveguides may be stacked on top of each other to form a waveguide stack. For example, each waveguide in the waveguide stack may be configured for manipulating light at a respective wavelength range which is beneficial for providing color images.

FIG. 3 shows an example of an optical device being a waveguide stack 50. The waveguide stack 50 may include a first cover glass 51 (bottom cover glass), a first waveguide 50A, a second waveguide 50B, a third waveguide 50C and a second cover glass 52 (top cover glass) stacked in this order. A first adhesive 53A may be disposed between the first cover glass 51 and the first waveguide 50A. A second adhesive 53B may be disposed between the first waveguide 50A and the second waveguide 50B. A third adhesive 53C may be disposed between the second waveguide 50B and the third waveguide 50C. A fourth adhesive 53D may be disposed between the third waveguide 50C and the second cover glass 52. Each of the waveguides 50A, 50B and 50C may be a waveguide as described herein, such as a waveguide 50 shown in FIGS. 2A and 2B.

A cover glass, such as the first cover glass 51 and/or the second cover glass 52, may be a protective glass. A cover glass may shield a surface of a waveguide adjacent to the cover glass, for example to prevent a grating formed on said surface from being contacted or contaminated. It may be the case that a cover glass itself does not have optical structures, such as a grating.

An adhesive, such as adhesives 53A-53D, may be configured to attach adjacent optical devices of a waveguide stack to each other. For example, the first adhesive 53A may be configured to attach the first cover glass 51 to the first waveguide 50A. The second adhesive 53B, the third adhesive 53C and the fourth adhesive 53D may be configured to attach the respective adjacent elements (50A, 50B, 50C, and 52) as shown exemplarily in FIG. 3. An adhesive may be a pressure sensitive adhesive (PSA). An adhesive may be a pre-formed adhesive, such as a pre-formed PSA. An adhesive may have an elongated shape. For example, an adhesive may be an adhesive tape. An adhesive may function as a spacer providing a gap, particularly an air gap, between adjacent optical devices of the waveguide stack. Due to the adhesive, it may be the case that said adjacent optical devices do not contact each other.

The waveguide stack 50 shown in FIG. 3 includes a total of three waveguides. The disclosure is not limited thereto. A waveguide stack may include one or more, two or more, or three or more waveguides. For example, a waveguide stack may include one waveguide and one cover glass, e.g. in the case where optical structures are provided on only one side of the waveguide and the cover glass is used to protect that optical structure. According to another example, a wave guide stack may include one or more of a total of two waveguides stacked between a first cover glass 51 and a second cover glass 52.

Furthermore, it is to be noted that instead of cover glasses, transparent cover elements made of materials other than glass may be used in a waveguide stack. Throughout the present disclosure, a cover glass may be replaced by a transparent cover element.

In the present disclosure, a “substrate” can be understood as a base or underlying material upon which other structures, layers or components are deposited or built. Typically, the substrate serves as a foundation or support for the subsequent layers or structures in a manufacturing process. A substrate according to the present disclosure is typically selected to transmit a suitable amount of light of a desired wavelength or wavelength range, such as one or more wavelengths from about 100 to about 3000 nanometers. For instance, the substrate may be of transparent glass or plastic. Without limitation, in some embodiments, the substrate is configured such that the optical device substrate transmits greater than or equal to approximately 50% to approximately 100% of an infrared to ultraviolet region of the light spectrum. For instance, the substrate may be of transparent glass or plastic. The substrate may be formed from any suitable material, provided that the substrate can adequately transmit light in a desired wavelength or wavelength range and can serve as an adequate support, e.g. for a waveguide combiner as described herein. Substrate selection may include optical device substrates of any suitable material, including, but not limited to, amorphous dielectrics, non-amorphous dielectrics, crystalline dielectrics, silicon oxide, polymers, and combinations thereof. In some embodiments, which may be combined with other embodiments described herein, the substrate includes a transparent material. In one embodiment, which may be combined with other embodiments described herein, the substrate is transparent with an absorption coefficient smaller than 0.001. Suitable examples may include silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), sapphire, or combinations thereof. In another embodiment, which may be combined with other embodiments described herein, the substrate has a refractive index greater than approximately 1.8. The substrate having a refractive index greater than approximately 1.8 includes, but is not limited to, lithium tantalate (LiTaO₃), lithium niobate (LiNbO₃), SiC, or combinations thereof.

In the present disclosure, the expression “defining individual edges of the plurality of optical devices” can be understood as a process or technique where boundaries or outlines of each optical device on the substrate surface are established for defining the shape and size of each optical device.

In the present disclosure, the expression “texturizing at least one portion of the individual edges” can be understood as a process or technique of creating texture on specific parts or sections of the edges or on the complete edges. In other words, specific areas or portions of the edges can be selected for the texturizing process or the complete edges of the optical devices can be selected for the texturizing process. Typically, texturizing involves modifying the surface of the edges to introduce a textured pattern, design, or roughness for functional purposes. The term “individual edges” implies that each edge of the plurality of optical devices is treated separately or individually rather than the entire edge as a whole.

In the present disclosure, the expression “removing material from the substrate surface” can be understood as a process or technique where material is selectively eliminated or subtracted from the surface of the substrate. A texturization obtained by removing material from the substrate surface may be referred to as subtractive created texturization. Accordingly, typically the recesses of the texturization extend from a main surface of the substrate (e.g. the front surface and/or the back surface of the substrate) into the substrate. The specific techniques used to remove material from the substrate surface can vary depending on the material and desired outcome. Examples of such techniques include etching, e.g. wet etching or dry etching, laser ablation, or other chemical or physical material removal techniques.

In the present disclosure, the expression “filling recesses of the at least one texturized portion with a light-absorbent material” can be understood as a process or technique where voids or depressions created during the texturizing process are filled with a material that absorbs light.

In the present disclosure, a “light-absorbent material” can be understood as a substance or composition that has the ability to absorb light energy rather than reflecting or transmitting the light. The light-absorbent material may include one or more types of particles, at least one of one or more dyes or one or more pigments, and a polymer matrix of one or more binders. In some embodiments, the light-absorbent composition may further include one or more filler dispersions, one or more photo initiators, one or more epoxy resins, one or more additives, one or more silanes, one or more isocyanates, one or more acids, one or more phosphine oxides, or combinations thereof. Examples of the filler dispersions include acrylates or methacrylates. Examples of the additives include amines or amides. Examples of the dyes include organic dyes. The one or more pigments include, but are not limited to, carbon black, carbon nanotubes, iron oxide black, black pigments, or combinations thereof. The one or more binders can be operable to be cured by radiation, e.g. to form a polymer matrix. Typically, the one or more types of particles are disposed in the polymer matrix. The one or more binders may include, but are not limited to, a UV curable binder, a LED curable binder, a thermal curable binder, an infrared curable binder, or combinations thereof.

Accordingly, according to some embodiments, which can be combined with other embodiments described herein, the method further includes curing the light-absorbent material, particularly prior to cutting the plurality of optical devices out of the substrate.

The one or more types of particles which may be used in a light-absorbent material include, but are not limited to, titanium oxide (Ti0₂), Si, zirconium oxide (Zr0₂), zinc oxide (ZnO), ferrosoferric oxide (Fe₃0₄), germanium (Ge), SiC, diamond, dopants thereof, or any combination thereof. The one or more types of particles includes at least one of nanoparticles or microparticles. Each nanoparticle (NP) or microparticle (MP) can be a coated particle, such as one, two, or more shells disposed around a core. In some examples, the NPs or MPs can contain one or more types of ligands coupled to the outer surface of the NPs or MPs (e.g., ligated NPs or stabilized NPs). The NPs or MPs can have one or more different shapes or geometries, such as spherical, oval, rod, cubical, wire, cylindrical, rectangular, or combinations thereof. The NPs can have a size or a diameter of approximately 2 nm, approximately 5 nm, approximately 8 nm, approximately 10 nm, approximately 12 nm, approximately 15 nm, approximately 20 nm, approximately 25 nm, approximately 30 nm, or approximately 35 nm to approximately 40 nm, approximately 50 nm, approximately 60 nm, approximately 80 nm, approximately 100 nm, approximately 150 nm, or approximately 200 nm. For example, the NPs can have a size or a diameter of approximately 2 nm to approximately 200 nm, approximately 2 nm to approximately 150 nm, approximately 2 nm to approximately 100 nm, approximately 2 nm to approximately 80 nm, approximately 2 nm to approximately 60 nm, approximately 2 nm to approximately 50 nm, approximately 2 nm to approximately 40 nm, approximately 2 nm to approximately 30 nm, approximately 2 nm to approximately 20 nm, approximately 2 nm to approximately 15 nm, approximately 2 nm to approximately 10 nm, approximately 10 nm to approximately 200 nm, approximately 10 nm to approximately 150 nm, approximately 10 nm to approximately 100 nm, approximately 10 nm to approximately 80 nm, approximately 10 nm to approximately 60 nm, approximately 10 nm to approximately 50 nm, approximately 10 nm to approximately 40 nm, approximately 10 nm to approximately 30 nm, approximately 10 nm to approximately 20 nm, approximately 10 nm to approximately 15 nm, approximately 50 nm to approximately 200 nm, approximately 50 nm to approximately 150 nm, approximately 50 nm to approximately 100 nm, approximately 50 nm to approximately 80 nm, or approximately 50 nm to approximately 60 nm.

Typically, a particle refractive index of the one or more types of particles is greater than 2.0. In some embodiments, which can be combined with other embodiments described herein, the particle refractive index of the one or more types of particles is approximately 2.4 or greater. The particle refractive index greater than 2.0 provides for the optically absorbent composition having a refractive index of approximately 1.7 or greater. The optical density of the optically absorbent composition of approximately 2.0 or greater is provided by the at least one of one or more dyes or one or more pigments. The refractive index of approximately 1.7 or greater and the optical density of approximately 2.0 or greater reduce the amount of stray light transmitted through the coating, which can be particularly advantageous in the case of edge coatings for reducing the amount of stray light scattered in the optical device.

In the present disclosure, the expression “cutting the plurality of optical devices out of the substrate” can be understood as a process or technique where the individual optical devices are physically separated or removed from the original substrate on which they were fabricated. For cutting the plurality of optical devices out of the substrate, cutting techniques such as sawing, dicing, laser cutting, or other suitable methods to precisely separate each device from the surrounding material can be employed. Once the cutting process is complete, the individual optical devices can undergo further processing, such as cleaning, inspection, testing, and packaging, in order to prepare them for use or distribution.

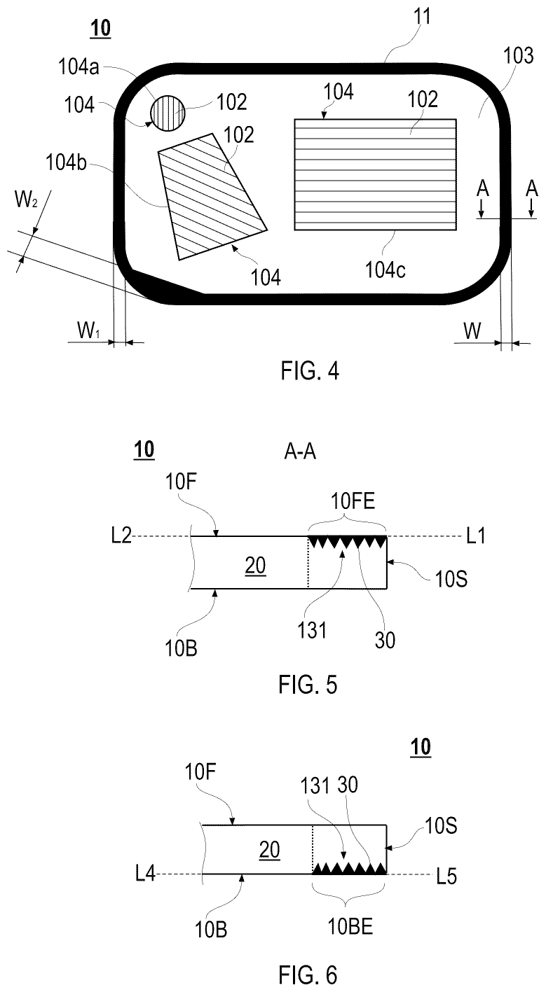

With respect to the aspects of light propagation within an optical device as described herein, the following can be noted. The skilled person understands that generally Snell's law (also known as Snell-Descartes law and or the law of refraction) can be applied. Snell's law is used to describe the relationship between the angles of incidence and refraction, when referring to light or other waves passing through a boundary between two different isotropic media, such as water, glass, air or other materials. For example, the internal angle of propagation of light trapped in total internal reflection (TIR) for a substrate with a refractive index n of n=2 typically spans from 30 to 90 degrees. Typically, the light bouncing within the optical device, e.g. a waveguide, fills mostly the range from 30 to 80 degree. For example, if the bouncing angle is higher than 71 degree, then, there might be beams that will pass below the blackening strip (recesses of the texturization filled with light-absorbent material as described herein) and hit directly the edge-wall at a small angle and may possibly pass through. The range from 71 to 80 degree can for example be covered increasing the width W of blackening strip, e.g. to W=4 mm or more. Such a widening may not be needed along the whole contour of the optical device, but can be applied in localized regions (see example with first width W₁ and second width W₂ described with reference to FIG. 4). For instance, high-intensity areas, non-active or non-visible areas may be provided with a wider blackening strip to effectively absorb light.

According to embodiments, which can be combined with any other embodiments described herein, filling the recesses 131 of the at least one texturized portion 13 with the light-absorbent material 30 includes pushing the light-absorbent material 30 into the recesses 131 of the at least one texturized portion 13. The expression “pushing the light-absorbent material into the recesses” can be understood as a process or technique where the light-absorbent material is physically inserted or applied into the recesses of the at least one texturized portion.

Advantages of pushing the light-absorbent material into the recesses include a complete filling and an enhanced adhesion resulting in improved optical properties. Pushing ensures that the light-absorbent material is effectively and uniformly distributed within the recesses. Accordingly, a thorough filling can be achieved, such that any gaps or voids that could compromise the optical performance can be avoided. Further, by pushing the material into the recesses, there is improved contact and adhesion between the light-absorbent material and the textured surface. This promotes stronger bonding and reduces the likelihood of the material dislodging or separating from the recesses over time. Thus, pushing the material into the recesses helps to optimize the light absorbent properties of the texturized portion. Accordingly, light absorption can be enhanced, reflections can be reduced, and overall optical efficiency and performance can be improved.

According to embodiments, which can be combined with any other embodiments described herein, filling the recesses of the at least one texturized portion with the light-absorbent material 30 includes using a screen-printing method. In particular, it is to be understood that the screen-printing method can be employed as a technique for pushing the light-absorbent material into the recesses of the texturized portion.

According to embodiments, which can be combined with any other embodiments described herein, a refractive index of the light-absorbent material 30 substantially matches a refractive index of the substrate 20.

When the refractive index of the light-absorbent material substantially matches the refractive index of the substrate, reflections at the interface between the light-absorbent material and the substrate can be minimized. The reduction in reflections leads to improved optical performance by minimizing unwanted light loss or interference. Furthermore, the matching refractive index beneficially allows for the efficient coupling of light into the light-absorbent material. This enhances light absorption within the material, maximizing its light-blocking or light-absorbing capabilities.

According to embodiments, which can be combined with any other embodiments described herein, removing material from the substrate surface 21 comprises using one or more techniques selected from the group consisting of wet etching, dry etching and laser ablation.

Wet etching is a process of selectively removing material from a substrate using a liquid or chemical solution. It involves immersing the substrate in an etchant that chemically reacts with and dissolves the exposed areas. Wet etching offers advantages such as selective removal, low cost, versatility in material compatibility, and high aspect ratio capabilities.

Dry etching refers to the removal of material from a substrate using a plasma or reactive gases. It involves bombarding the substrate surface with ions or reactive species, which chemically react with and etch away the exposed areas. Dry etching techniques include plasma etching, reactive ion etching (RIE), and ion beam etching. Dry etching offers advantages such as high etching rates, anisotropic etching (ability to etch in specific directions), precise control over etching profiles, and compatibility with high-resolution patterning.

Laser ablation is a technique that utilizes a high-intensity laser beam to remove material from a substrate through vaporization or melting. The laser energy is focused on the target area, causing rapid heating and material removal. Laser ablation is highly precise, with the ability to create intricate patterns and structures. It offers advantages such as high resolution, minimal heat-affected zone, minimal contamination, and suitability for a wide range of materials.

In summary, wet etching is suitable for low-cost, selective, and high aspect ratio etching. Dry etching techniques provide faster etching rates, anisotropic etching, and precise control over etching profiles. Laser ablation offers high precision, minimal heat impact, and versatility for various materials. The choice of technique depends on the specific application requirements, material characteristics, desired etching profile, and cost considerations.

According to embodiments, which can be combined with any other embodiments described herein, texturizing comprises creating one or more of a random texture, a targeted random texture, a randomized grating, an oriented grating, and a microstructure, particularly comprising a plurality of micro pyramids.

In the present disclosure, a “random texture” can be understood as a surface pattern that lacks a specific repeating or ordered arrangement. Typically, the random texture is characterized by irregularities, variations, or fluctuations in its features, such as roughness, bumps, or depressions.

In the present disclosure, a “targeted random texture” can be understood as a surface pattern with a random appearance but specific spatial frequencies that are tuned or controlled.

In the present disclosure, a “randomized grating” can be understood as a pattern that combines elements of a regular grating structure with randomness. For instance, the randomized grating may consist of alternating structures, e.g. lines, ridges, or grooves that vary in spacing, orientation, or height. The irregularity in the pattern breaks the regularity of a typical grating, resulting in a more scattered or disordered appearance.

In the present disclosure, an “oriented grating” can be understood as a pattern where the structures, e.g. lines, ridges, or grooves are aligned or oriented in a specific direction. Unlike a random or randomized grating, an oriented grating maintains a consistent orientation or periodicity in its pattern. Oriented gratings can be designed to control the behavior of light, such as enhancing light extraction or creating directional light patterns.

In the present disclosure, a “microstructure” refers to a small-scale structure or feature with dimensions typically in the micrometer range. In the context of texturizing, a microstructure can be understood as a specific pattern or arrangement of small-scale elements on the surface. For example, a microstructure can consist of a plurality of micro pyramids, which are tiny pyramid-shaped structures distributed across the texturized surface of the substrate.

According to embodiments, which can be combined with any other embodiments described herein, there may be variations in the textures found on different locations around the circumference of the edges of the plurality of optical devices. The variation may arise due to intentional design choices or variations in the manufacturing process. By purposely introducing different textures as described herein, such as random textures, randomized gratings, or oriented gratings, at specific locations, unique optical effects or functional characteristics can be achieved. For example, different textures can be implemented to optimize light scattering in one region or control the directionality of light. Localized variations in texture can contribute to the overall performance and versatility of the optical devices, allowing for tailored functionality in specific regions or addressing different requirements across the circumference.

According to embodiments, which can be combined with any other embodiments described herein, the at least one portion of the individual edges has a band width W of 1.0 mm≤W≤3.0 mm, particularly 1.5 mm≤W≤2.5 mm. The band width W is indicated exemplarily in FIG. 4.

With exemplary reference to FIG. 4, according to embodiments, which can be combined with any other embodiments described herein, the at least one portion of the individual edges comprises a first portion having a first width W₁ and a second portion having a second width W₂, wherein the first width W₁ is smaller than the second width. For instance, the first width W₁ can be 1.0 mm≤W₁≤3.0 mm. The second width W₂ can be 3.0 mm<W₂≤5.0 mm.

With exemplary reference to FIGS. 4, 5 and 6, an optical device 10 according to embodiments of the present disclosure is described. According to embodiments, which can be combined with any other embodiments described herein, the optical device 10 includes substrate with a front surface 10F, a back surface 10B and a circumferential side surface 10S. At least one portion of an edge 10FE of the front surface has a subtractive created texturization, wherein recesses 13 of the texturization are filled with a light-absorbent material 30. Additionally or alternatively, at least one portion of an edge 10BE of the back surface may have a subtractive created texturization. The recesses 13 of the texturization are filled with a light-absorbent material 30, as exemplarily shown in FIG. 6. It is to be noted, that the circumferential side surface 10S is free of light-absorbent material.

According to embodiments, which can be combined with any other embodiments described herein, the recesses 13 of the texturization extend from the front surface 10F into the substrate. Accordingly, the recesses ay be considered to be below the level of the front surface.

According to embodiments, which can be combined with any other embodiments described herein, at least one portion of an edge of the back surface can have a texturization, wherein the recesses of the texturization extend from the back surface 10B into the substrate of the optical device substrate and are filled with a light-absorbent material.

With exemplary reference to FIG. 4, according to embodiments, which can be combined with any other embodiments described herein, the optical device 10 includes a plurality of structures 102 disposed on a surface 103 of the substrate. The structures 102 may be nanostructures having sub-micron dimensions, e.g., nano-sized dimensions. For instance, the optical device 10 can be a waveguide combiner. The waveguide combiner typically includes regions of the structures 102 corresponding to one or more gratings 104, such as a first grating 104a, a second grating 104b, and a third grating 104c. In particular, the waveguide combiner may include at least the first grating 104a corresponding to an input coupling grating and the third grating 104c corresponding to an output coupling grating. The waveguide combiner may further include the second grating 104b corresponding to an intermediate grating.

In operation of the waveguide combiner a virtual image is projected from a near-eye display, such as a microdisplay, to the first grating 104a. The structures 102 of the first grating 104a couple-in the incident beams of light of the virtual image and diffract the incident beams to the second grating 104b. The diffracted beams undergo total-internal-reflection (TIR) through the waveguide combiner 100 until the diffracted beams come in contact with structures 102 of the second grating 104b. The diffracted beams from the first grating 104a that are incident on the second grating 104b are split into a first portion of beams that are refracted back or lost in the waveguide combiner 100, a second portion of beams that undergo TIR in the second grating 104b until the second portion of beams contact another structure of the plurality of structures 102 of the second grating 104b, and a third portion of beams that are coupled through the waveguide combiner 100 to the third grating 104c. The beams of the second portion of beams that undergo TIR in the second grating 104b continue to contact structures of the plurality of structures 102 until either the intensity of the second portion of beams coupled through the waveguide combiner 100 to the second grating 104b is depleted, or remaining second portion of beams propagating through the second grating 104b reach the end of the second grating 104b.

The beams pass through the waveguide combiner 100 to the third grating 104c and undergo TIR in the waveguide combiner 100 until the beams contact a structure of the plurality of gratings 102 of the third grating 104c where the beams are split into beams that are refracted back or lost in the waveguide combiner 100, beams that undergo TIR in the third grating 104c until the beams contact another structure of the plurality of gratings 102, or beams that are coupled-out from the waveguide combiner 100 to the user's eye. The beams that undergo TIR in the third grating 104c continue to contact structures of the plurality of gratings 102 until the either the intensity of the beams passing through the waveguide combiner 100 to the third grating 104c is depleted, or remaining beams propagating through the third grating 104c have reached the end of the third grating 104c. The beams of the virtual image are propagated from the third grating 104c to overlay the virtual image over the ambient environment.

Typically, some light provided to the waveguide combiner strays from the intended path discussed above. For example, in some instances, a fraction of beams, i.e., stray light, reaches an edge 11 of the waveguide combiner 100. Upon reaching the edge 11, the stray light can then be (1) transmitted through the edge 11, (2) reflected, or scattered, through the waveguide combiner at a variety of angles, or (3) absorbed at the edge 11. Stray light that is transmitted through the edge 11 and/or stray light that is scattered from the edge 11 through the waveguide combiner reduce the quality of virtual image via noise from the stray light. To reduce the amount of stray light transmitted through the edge 11 and the amount of stray light scattered in the waveguide combiner by the edge 11, the edge 11 includes a texturization, wherein recesses of the texturization are filled with a light-absorbent material, as described herein.

According to embodiments, which can be combined with any other embodiments described herein, the at least one portion of the edge 10FE of the front surface having the texturization with recesses 131 filled with the light-absorbent material 30 provides a front edge surface which is at the same level as an adjacent non-edge surface of the front surface 10F. For illustration purposes, the level L1 of the front edge surface and the level L2 of the adjacent non-edge surface of the front surface 10F are indicated in FIG. 5

Additionally or alternatively, the at least one portion of the edge 10BE of the back surface 10B having the texturization with recesses 131 filled with the light-absorbent material 30 provides a back-edge surface which is at the same level as an adjacent non-edge surface of the back surface 10B. For illustration purposes, the level L3 of the back-edge surface and the level LA of the adjacent non-edge surface of the back surface 10B are indicated in FIG. 6.

It is to be understood that the optical device 10 according to embodiments described herein can be manufactured by a method 100 of manufacturing a plurality of optical devices 10 according to embodiments described herein.

In view of the embodiments described herein, it is to be understood that, compared to the state of the art, that the method of manufacturing a plurality of optical devices offers several advantages.

The method allows for the simultaneous fabrication of multiple optical devices on a single substrate. This enables mass production and increased manufacturing efficiency, reducing the time and cost associated with producing individual devices one by one. Accordingly, scalability can be improved.

By defining the individual edges of the optical devices on the substrate, the method ensures a high level of precision and consistency in the shape and size of each device. This is crucial for maintaining uniformity and meeting strict performance specifications across the entire batch of devices. Accordingly, precision and consistency can be improved.

Furthermore, filling the recesses of the texturized portions with a light-absorbent material helps to optimize the optical performance of the devices. It reduces unwanted reflections, scattering, or stray light, resulting in enhanced optical efficiency, contrast, and image quality.

By fabricating multiple optical devices on a single substrate, the method optimizes material usage. It minimizes material waste and maximizes yield, resulting in cost savings and resource efficiency.

Moreover, embodiments of the method as described herein integrate various manufacturing steps, including defining edges, texturizing, filling recesses, and cutting, into a coherent and efficient process flow. This streamlined approach reduces handling, setup, and transition times, improving overall productivity and throughput.

Additionally, embodiments of the method as described herein facilitate effective quality control measures since the manufacturing process is performed on a single substrate. This allows for easy monitoring, inspection, and testing of the devices during and after fabrication, ensuring adherence to quality standards and the early identification of any defects or issues.

Finally, after the optical devices are cut out of the substrate, they are readily available as individual components for further assembly or integration into larger systems. This simplifies the assembly process and enables efficient integration into various optical devices or applications.

Overall, the method of manufacturing a plurality of optical devices as described in the present disclosure offers advantages such as scalability, precision, customization, improved optical performance, efficiency, and quality control. These benefits contribute to cost-effective production, consistent device quality, and enhanced functionality in optical applications.

While the foregoing is directed to implementations of the present disclosure, other and further implementations of the disclosure may be devised without departing from the basic scope thereof, and the scope thereof is determined by the claims that follow.

1. An optical device, comprising a substrate with a front surface, a back surface and a circumferential side surface, wherein at least one portion of an edge of the front surface has a texturization, wherein recesses of the texturization are filled with a light-absorbent material, and wherein the circumferential side surface is free of light-absorbent material.

2. The optical device of claim 1, wherein the recesses of the texturization extend from the front surface into the substrate.

3. The optical device of claim 1 or 2, wherein at least one portion of an edge of the back surface has a texturization, and wherein the recesses of the texturization extend from the back surface into the substrate and are filled with a light-absorbent material.

4. The optical device any of claims 1 to 3, wherein the at least one portion of the edge of the front surface having the texturization with recesses filled with the light-absorbent material provides a front edge surface which is at the same level as an adjacent non-edge surface of the front surface.

5. The optical device of any of claims 1 to 4, wherein the at least one portion of the edge of the back surface having the texturization with recesses filled with the light-absorbent material provides a back-edge surface which is at the same level as an adjacent non-edge surface of the back surface.

6. The optical device of any of claims 1 to 5, wherein the optical device is selected from the group consisting of: a waveguide, a wave guide combiner, a flat optical device, a substrate having optical structures, a cover glass, a lens and a metasurface lens.

7. The optical device of any of claims 1 to 6, wherein the optical device is selected from the group consisting of: a waveguide, a wave guide combiner, a flat optical device, a substrate having optical structures, a cover glass, a lens and a metasurface lens.

8. The optical device of any of claims 1 to 7, wherein the substrate is made of transparent material comprising one or more constituents selected from the group consisting of silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), sapphire, lithium tantalate (LiTaO₃), lithium niobate (LiNbO₃), or combinations thereof.

9. The optical device of any of claims 1 to 8, the optical device being manufactured by a method according to any of claims 10 to 20.

10. A method of manufacturing a plurality of optical devices, comprising:
defining individual edges of the plurality of optical devices on a substrate surface;
texturizing at least one portion of the individual edges by removing material from the substrate surface;
filling recesses of the at least one texturized portion with a light-absorbent material; and
cutting the plurality of optical devices out of the substrate.

11. The method of claim 10, wherein filling the recesses of the at least one texturized portion with the light-absorbent material comprises pushing the light-absorbent material into the recesses of the at least one texturized portion.

12. The method of claim 10 or 11, wherein filling the recesses of the at least one texturized portion with the light-absorbent material comprises using a screen-printing method.

13. The method of any of claims 10 to 12, wherein a refractive index of the light-absorbent material substantially matches a refractive index of the substrate.

14. The method of any of claims 10 to 13, wherein removing material from the substrate surface comprises using one or more techniques selected from the group consisting of: wet etching, dry etching and laser ablation.

15. The method of any of claims 10 to 14, wherein texturizing comprises creating one or more of a random texture, a targeted random texture, a randomized grating, an oriented grating, a microstructure, particularly a microstructure comprising a plurality of micro pyramids.

16. The method of any of claims 10 to 15, wherein the at least one portion of the individual edges has a band width W of 1.0 mm≤W≤3.0 mm, particularly 1.5 mm≤W≤2.5 mm.

17. The method of any of claims 10 to 16, wherein the at least one portion of the individual edges comprises a first portion having a first width W₁ and a second portion having a second width W₂, wherein the first width W₁ is smaller than the second width, particularly wherein 1.0 mm≤W₁≤3.0 mm and 3.0 mm<W₂≤5.0 mm.

18. The method of any of claims 10 to 17, further comprising curing the light-absorbent material, particularly prior to cutting the plurality of optical devices out of the substrate.

19. The method of any of claims 10 to 18, wherein the optical devices are selected from the group consisting of: a waveguide, a wave guide combiner, a flat optical device, a substrate having optical structures, a cover glass, a lens and a metasurface lens.

20. The method of any of claims 10 to 19, wherein the substrate is made of transparent material comprising one or more constituents selected from the group consisting of silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), sapphire, lithium tantalate (LiTaO₃), lithium niobate (LiNbO₃), or combinations thereof.
